(19) United States
(12) Patent Application Publication
(10) Pub. No.: US 2024/0413346 A1
(43) Pub. Date: Dec. 12, 2024

(54) ELECTRODE ASSEMBLY FOR RECHARGEABLE LITHIUM BATTERIES AND RECHARGEABLE LITHIUM BATTERY INCLUDING THE SAME

(71) Applicant: SAMSUNG SDI CO., LTD., Yongin-si (KR)

(72) Inventors: Hyo Jung SONG, Suwon-si (KR); Jin Hee LEE, Suwon-si (KR); Ho Sung YANG, Suwon-si (KR); Kyo Seon KOO, Suwon-si (KR); Duck Jae YOU, Suwon-si (KR); Jung Hyun NAM, Suwon-si (KR)

(21) Appl. No.: 18/737,692

(22) Filed: Jun. 7, 2024

(30) Foreign Application Priority Data
Jun. 8, 2023 (KR) 10-2023-0073378

(51) Int. Cl. H01M 4/62; H01M 4/02; H01M 4/133; H01M 4/36; H01M 4/587; H01M 10/0525

(52) U.S. Cl. CPC H01M 4/628; H01M 4/133; H01M 4/366; H01M 4/587; H01M 10/0525; H01M 2004/021

(57) ABSTRACT

An electrode assembly for a rechargeable lithium battery and a rechargeable lithium battery are disclosed. The electrode assembly for a rechargeable lithium battery includes a negative electrode and a positive electrode, wherein the negative electrode includes a current collector; a negative electrode active material layer on the current collector and including a negative electrode material; and a first functional layer and an organic-inorganic composite layer sequentially on the negative electrode active material layer, the first functional layer being integrated with the negative electrode material layer, and wherein the positive electrode includes a second functional layer facing the organic-inorganic composite layer.

### CROSS-REFERENCE TO RELATED APPLICATION

The present application claims priority to and the benefit of Korean Patent Application No. 10-2023-0073378, filed on Jun. 8, 2023, in the Korean Intellectual Property Office, the entire content of which is hereby incorporated by reference.

### BACKGROUND

### 1. Field

Embodiments of the present disclosure relate to an electrode assembly for rechargeable lithium batteries and a rechargeable lithium battery including the same.

### 2. Description of the Related Art

In recent years, demand for small, lightweight and relatively high-capacity rechargeable batteries has grown rapidly with rapid proliferation of electronic devices using batteries, such as mobile phones, notebook computers, and electric vehicles. For example, rechargeable lithium batteries have attracted attention as a power source for portable devices due to their light weight and high energy density. Research and development have been actively carried out to improve performance of rechargeable lithium batteries.

A rechargeable lithium battery refers to a battery that include a positive electrode and a negative electrode, which include an active material allowing intercalation and deintercalation of lithium ions, and an electrolyte to generate electric energy through oxidation and reduction upon intercalation and deintercalation of lithium ions in the positive electrode and the negative electrode.

As positive electrode active materials for rechargeable lithium batteries, transition metal compounds, such as lithium cobalt oxide, lithium nickel oxide, lithium manganese oxide, and/or the like, have been used. As negative electrode active materials for rechargeable lithium batteries, crystalline carbon active materials, such as natural graphite and/or artificial graphite, and/or non-crystalline carbon active materials have been used.

### SUMMARY

It is one aspect of embodiments of the present disclosure to provide an electrode assembly for a rechargeable lithium battery, which can secure suppression or reduction of growth of lithium dendrites, efficient suppression or reduction of a side reaction, good cell reliability, good processability, good high temperature storage stability, and good thermal stability.

It is one aspect of embodiments of the present disclosure to provide a rechargeable lithium battery including the electrode assembly.

In accordance with one aspect of embodiments of the present disclosure, there is provided an electrode assembly for a rechargeable lithium battery, which includes a negative electrode and a positive electrode, wherein the negative electrode includes a current collector; a negative electrode active material layer on the current collector and including a negative electrode active material; and a first functional layer and an organic-inorganic composite layer sequentially formed on the negative electrode active material layer, the first functional layer being integrated with the negative electrode active material layer, and wherein the positive electrode includes a second functional layer facing the organic-inorganic composite layer.

In accordance with another aspect of embodiments of the present disclosure, there is provided a rechargeable lithium battery including the electrode assembly; and an electrolyte.

Embodiments of the present disclosure provide an electrode assembly for rechargeable lithium batteries, which can secure suppression or reduction of growth of lithium dendrites, efficient suppression or reduction of side-effects, good cell reliability, good processability, good high temperature storage stability, and good thermal stability.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a schematic view of an electrode assembly for rechargeable lithium batteries according to one embodiment of the present disclosure.

FIG. 2 is a schematic view of a rechargeable lithium battery according to one embodiment of the present disclosure.

### DETAILED DESCRIPTION

Hereinafter, example embodiments of the present disclosure will be described in more detail with reference to the accompanying drawings. However, it should be understood that these embodiments are provided for illustration only and the present disclosure is not limited thereto and is defined by the appended claims and equivalents thereto.

The terminology used herein is for the purpose of describing example embodiments and is not intended to limit the scope of the disclosure. Herein, the singular forms “a,” “an,” and “the” are intended to include the plural forms as well, unless the context clearly indicates otherwise.

Herein, “combinations thereof” mean a mixture, stack, composite, copolymer, alloy, blend, and/or a reaction product of components, and/or the like.

Herein, unless specifically stated otherwise, it should be understood that the terms, such as “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

In the drawings, thicknesses may be enlarged to clearly represent different layers and regions, and like components will be denoted by like reference numerals throughout the specification. If an element, such as a layer, a membrane, a region, a plate, or the like, is referred to as being “above” or “on” another element, it may be directly above or on the element, or intervening elements may be present. However, if an element is referred to as being “directly above” or “directly on” another element, there are no intervening elements present.

Herein, “layer” includes not only a shape on an overall plane but also a shape partially on a plane in a plan view.

Herein, “average particle diameter” may be measured by any suitable method generally used in the art. For example, the average particle diameter may be measured by a particle size analyzer, a transmission electron micrograph and/or a scanning electron micrograph. In another method, the average particle diameter may be obtained by counting and averaging the number of particles in each particle size range through measurement and data analysis of particle sizes using a dynamic light scattering method. The average particle diameter may be measured by a microscope image and/or a particle size analyzer and means a particle diameter (D50) corresponding to 50 vol % in a volume cumulative distribution of particles using a particle size analyzer.

Herein, “or” should not be interpreted as an exclusive meaning. For example, “A or B” is interpreted as including A, B, A+B, and/or the like.

### Electrode Assembly for Rechargeable Lithium Batteries

An electrode assembly for rechargeable lithium batteries according to one embodiment includes a negative electrode and a positive electrode. The negative electrode includes a current collector, a negative electrode active material layer on the current collector, and a first functional layer and an organic-inorganic composite layer sequentially formed on the negative electrode active material layer, in which the first functional layer is integrated with the negative electrode active material layer. The positive electrode includes a second functional layer facing the organic-inorganic composite layer.

The organic-inorganic composite layer serves as a separator that is between the positive electrode and the negative electrode active material layer and prevents short circuit (or reduces a likelihood or occurrence of a short circuit). The electrode assembly for rechargeable lithium batteries according to the embodiment does not include a separate or independent separator. Accordingly, the electrode assembly for rechargeable lithium batteries enables economical (e.g., low cost) fabrication of batteries by eliminating a lamination process in which the separator is coupled to the electrodes.

The organic-inorganic composite layer includes an organic layer and an inorganic layer, and may be composed of at least two layers, for example, may be two layers. In embodiments, “organic layer” means a layer including 90 wt % or more, for example, 95 wt % to 100 wt %, of an organic component based on the total weight of the components of the organic layer. In embodiments, “inorganic layer” means a layer including 90 wt % or more, for example, 95 wt % or more, 95 wt % to 100 wt %, or 95 wt % to 99 wt %, of an inorganic component based on the total weight of the components of the inorganic layer.

In one embodiment, the organic-inorganic composite layer may include 20 wt % to 50 wt % of the organic layer and 50 wt % to 80 wt % of the inorganic layer based on 100 wt % of the organic-inorganic composite layer. Within these ranges, the effects of the present disclosure can be easily realized.

In the organic-inorganic composite layer, the organic layer and the inorganic layer may be integrated with each other. Herein, “integrated” means a structure in which one layer is directly formed on another layer through diffusion of one component of the one layer into the other layer rather than a structure in which two layers are independently formed as separate layers. This can be clearly seen as an interface (or boundary) between the one layer and the other is not completely clear and uneven. This can be confirmed by scanning electron microscopy (SEM) and/or transmission electron microscopy (TEM). Integration of the organic layer and the inorganic layer allows the organic layer and the inorganic layer to be present in a firmly coupled state. In one embodiment, the organic-inorganic composite layer may be formed by directly forming the inorganic layer on the organic layer or by directly forming the organic layer on the inorganic layer.

The organic layer may have a thickness of 1 μm to 20 μm, for example, 1 μm to 8 μm. In embodiments, the thickness of the organic layer means a thickness of a region of the organic-inorganic composite layer in which an organic component is present in the form of a layer rather than a thickness of a region in which the organic component is independently present. Within the above thickness ranges, the organic layer can have a suitably high density.

In the organic layer, the organic component may include a heat-resistant polymer. The heat-resistant polymer can improve reliability of the organic-inorganic composite layer in a battery. The heat-resistant polymer may be a highly heat-resistant engineering resin. The heat-resistant polymer may include, for example, polyethylene (PE), polypropylene (PP), polyester, polyamide, polyimide (PI), polyamideimide (PAI), polyetherimide, polyacrylonitrile (PAN), polyvinylidene fluoride (PVDF), polyvinylidene fluoride-hexafluoropropylene (PVDF-HFP), polycarbonate (PC), polyvinyl chloride (PVC), polyvinylidene chloride, polyethylene glycol derivatives, polyoxide, polyvinyl acetate, polystyrene (PS), polyvinylpyrrolidone (PVP), copolymers thereof, or combinations thereof. According to one embodiment, the heat-resistant polymer may be a non-aqueous polymer. Aqueous polymers can make it difficult to form fibers by electrospinning described below and thus can be unsuitable for formation of the organic layer. In embodiments, the organic component of the organic layer may be a mixture of polyvinylidene fluoride and polyacrylonitrile.

In one embodiment, the organic layer may be present in a woven state or in a non-woven state, for example, a network structure. In embodiments, the organic layer having a network structure can minimize or reduce resistance to migration of Li ions. The woven state of the organic layer may mean that the organic layer is a porous layer having pores therein. If the organic layer is formed as a dense layer, it can be unsuitable or inappropriate due to relative increase in resistance to migration of Li ions through increase in travel distance of the Li ions.

The inorganic layer may have a thickness of 1 μm to 20 μm, for example, 1 μm to 8 μm. In embodiments, the thickness of the inorganic layer means a thickness of a region of the organic-inorganic composite layer in which an inorganic component is present in the form of a layer rather than a thickness of a region in which the inorganic component is independently present. Within the above thickness ranges, the inorganic layer can have a suitably high density to suppress or reduce generation of Li dendrites.

The inorganic component of the inorganic layer may be ceramic. In embodiments, the ceramic suppresses or reduces generation of lithium dendrites. For example, the ceramic may include minerals of alumina (Al₂O₃), boehmite (aluminum oxide hydroxide), zirconia, titanium oxide (TiO₂), silica (SiO₂), or combinations thereof. According to one embodiment, the ceramic may be alumina and/or boehmite. The inorganic component may have an average particle diameter (D50) of 100 nm to 500 nm, for example, 200 nm to 450 nm, or 300 nm to 400 nm. Within the above ranges, the inorganic component can assist in improvement of air permeability.

In one embodiment, the inorganic layer may further include an organic component in addition to the inorganic component. The organic component may facilitate formation of the inorganic layer, as compared with the inorganic layer including the inorganic component alone. The organic component may be polyvinylidene fluoride, polyamideimide, polyvinylpyrrolidone, polyacrylonitrile, polyacrylic acid (PAA), a copolymer thereof, or a combination thereof.

In one embodiment, the inorganic layer may include the inorganic component and the organic component in a weight ratio of 10:1 to 30:1, for example, 15:1 to 25:1. Within the above ranges, the effects of the inorganic layer can be easily realized.

The inorganic layer may be a dense layer. In embodiments, “dense layer” means a layer in which the size or formation of pores in the organic layer is minimized or reduced. If present as the dense layer, the inorganic layer can more effectively suppress or reduce formation of lithium dendrites, and if the inorganic layer is present as a porous layer, the inorganic layer can cause short circuit upon charge/discharge of a battery.

Because the organic-inorganic composite layer includes the organic layer and the inorganic layer, the organic-inorganic composite layer can impart heat resistance through the presence of a polymer, for example, a heat-resistant polymer, and flexibility to the negative electrode. As a result, the organic-inorganic composite layer can suppress or reduce damage to the negative electrode in a battery fabrication process and generation of lithium dendrites upon charge/discharge while improving heat resistance and mechanical strength through the inorganic component. Such effects cannot be achieved by a single layer formed of a mixture of the polymer and the inorganic material.

If the negative electrode includes an organic layer, for example, an organic layer having a woven state, for example, a network structure, alone instead of the organic-inorganic composite layer in the negative electrode, the electrode assembly can suffer from a problem of direct contact between the positive electrode and the negative electrode and/or generation of lithium dendrites upon charging, thereby causing failure in operation of a battery due to short circuit. If the negative electrode includes the organic layer alone, the electrode assembly can suffer from a similar problem even with a bilayer organic layer.

If the negative electrode includes the inorganic layer alone, the negative electrode has insufficient flexibility and suffers from deintercalation of particles of the inorganic layer upon battery assembly, thereby causing generation of lithium dendrites, and the electrode assembly can suffer from short circuit due to generation of the lithium dendrites.

In one embodiment, the organic-inorganic composite layer may be integrated with the first functional layer to be present in a more firmly coupled state than the negative electrode active material layer. In general, if used as the separator, a polypropylene film can suffer from dimensional variation due to thermal shrinkage and the like upon repetition of charge/discharge, thereby causing short circuit through deterioration in a function of separating the positive electrode and the negative electrode. In the electrode assembly according to one embodiment, the organic-inorganic composite layer capable of acting as a separator is integrated with the negative electrode active material layer via the first functional layer, thereby minimizing or reducing occurrence of problems, such as thermal shrinkage and/or the like. Further, as the organic-inorganic composite layer is integrated with the negative electrode active material layer via the first functional layer, the organic-inorganic composite layer can reduce resistance (e.g., decrease resistance to migration of lithium ions) while improving heat resistance and insulating properties (e.g., electrically insulating properties). If the organic-inorganic composite layer is formed as a separate layer in the electrode assembly instead of being integrated with the negative electrode active material layer, the organic-inorganic composite layer is not integrated with the negative electrode active material layer, thereby causing increase in resistance to migration of lithium ions and addition of a process for integration.

In one embodiment, the organic-inorganic composite layer may also be integrated with the second functional layer.

In one embodiment, the organic-inorganic composite layer may have a thickness of less than 14 μm, for example, greater than 0 μm to less than 14 μm, 1 μm to 13 μm, or, for example, 8 μm to 11 μm. Within the above ranges, the electrode assembly can have a thin structure and can achieve remarkable improvement in battery efficiency through reduction in lithium ion migration resistance and distance of lithium ions. In embodiments, the thickness of the “organic-inorganic composite layer” means an overall thickness of a region in which the organic component is present in the form of a layer and a region in which the inorganic component is present in the form of a layer, rather than the thickness of a region in which the organic component or the inorganic component is independently present.

In one embodiment, the electrode assembly includes the first functional layer and the second functional layer described below together with the organic-inorganic composite layer having a thickness within the above ranges, thereby suppressing or reducing growth of lithium dendrites and a gas side reaction while improving reliability, stability, lifespan and high temperature storage of batteries.

The first functional layer is integrated with the negative electrode active material layer. The first functional layer serves to suppress or reduce growth of dendrites in the negative electrode active material layer. Further, the first functional layer can improve battery reliability by suppressing or reducing potential increase and a side reaction on the surface of the negative electrode active material layer. According to one embodiment, if the organic-inorganic composite layer has a thickness of less than 14 μm, for example, greater than 0 μm to less than 14 μm, 1 μm to 13 μm, or 8 μm to 11 μm, the first functional layer may be effective in suppression or reduction of growth of lithium dendrites in the negative electrode active material layer while improving battery reliability.

Although the first functional layer is integrated with the negative electrode material active layer, these layers are different layers.

According to one embodiment, the first functional layer can improve bonding strength of the organic-inorganic composite layer to the negative electrode active material layer through integration with each of the negative electrode active material layer and the organic-inorganic composite layer, thereby improving reliability, stability, lifespan and high temperature storage of batteries.

The first functional layer may be an inorganic layer including an inorganic component. The inorganic component may include at least one selected from among lithium titanium oxide (LTO), silicon oxide (SiOx), and silicon carbon nanocomposite (SCN). In one embodiment, the inorganic component may be present in an amount of 90 wt % or more, for example, 90 wt % to 100 wt %, or 93 wt % to 98 wt %, in the first functional layer, based on 100 wt % of the first functional layer. Within the above ranges, the first functional layer can suppress or reduce growth of dendrites while improving battery reliability. In one embodiment, the inorganic component may be lithium titanium oxide (LTO).

The inorganic component refers to particles having a spherical, semi-spherical, elliptical and/or amorphous cross-section and may have a greater average particle diameter D50 than the inorganic component of the organic-inorganic composite layer. As a result, the inorganic component can secure efficient improvement in dispersion of slurries for the first functional layer and the effects of embodiments of the present disclosure. In one embodiment, the inorganic component may have an average particle diameter (D50) of 1 μm to 10 μm, for example, 1 μm to 5 μm, 1 μm to 3 μm, or 1 μm to 2 μm.

The first functional layer may further include an organic component. The organic component may facilitate formation of the first functional layer without affecting the function of the inorganic component even in a smaller amount than the inorganic component. In one embodiment, the organic component may be present in an amount of 10 wt % or less, for example, 0 wt % to 10 wt %, or 2 wt % to 7 wt %, in the first functional layer, based on 100 wt % of the first functional layer. Within the above ranges, the organic component can facilitate formation of the first functional layer without affecting the function of the first functional layer. The organic component may include at least one of the organic components for the organic layer described above, without being limited thereto. In one embodiment, the organic component may be polyvinylidene fluoride (PVDF).

The first functional layer may have a thickness of 1 μm to 5 μm or, for example, 2 μm to 5 μm. Within the above ranges, the first functional layer can suppress or reduce growth of lithium dendrites in the negative electrode active material layer without affecting the effects of embodiments of the organic-inorganic composite layer. In embodiments, the thickness of the first functional layer means a thickness of a region interposed as a mixed layer of the inorganic component and the organic component between the organic-inorganic composite layer and the negative electrode active material layer rather than a thickness of a region in which the inorganic component is present alone.

The second functional layer may be between the organic-inorganic composite layer and the positive electrode and serves to improve reliability, stability, lifespan and high temperature storage of batteries through reduction in a gas side reaction. In one embodiment, if the organic-inorganic composite layer has a thickness of less than 14 μm, for example, greater than 0 μm to less than 14 μm, 1 μm to 13 μm, or 8 μm to 11 μm, the second functional layer can improve reliability, stability, lifespan and high temperature storage of batteries through reduction in a gas side reaction.

The second functional layer can improve bonding strength of the organic-inorganic composite layer to the positive electrode through integration with the positive electrode, thereby improving reliability, stability, lifespan and high temperature storage of batteries.

The second functional layer may be integrated with the organic-inorganic composite layer or may be independent of the organic-inorganic composite layer.

The second functional layer may be an inorganic layer including an inorganic component. The inorganic component may include lithium ferrophosphate (LFP). In one embodiment, the inorganic component may be present in an amount of 90 wt % or more, for example, 90 wt % to 100 wt %, or 93 wt % to 98 wt %, in the second functional layer, based on 100 wt % of the second functional layer. Within the above ranges, the inorganic component can improve battery reliability through suppression or reduction of a side reaction.

The inorganic component refers to particles having a spherical, semi-spherical, elliptical or amorphous cross-section and may have a greater average particle diameter D50 than the inorganic component of the organic-inorganic composite layer. As a result, the inorganic component can secure efficient improvement in dispersion of slurries for the second functional layer and the effects of the present disclosure. In one embodiment, the inorganic component may have an average particle diameter (D50) of 1 μm to 10 μm, for example, 1 μm to 5 μm, 1 μm to 3 μm, or 1 μm to 2 μm.

The second functional layer may further include an organic component. The organic component may facilitate formation of the second functional layer without (or substantially without) affecting the function of the inorganic component even in a smaller amount than the inorganic component. In one embodiment, the organic component may be present in an amount of 10 wt % or less, for example, 0 wt % to 10 wt %, or 2 wt % to 7 wt %, in the second functional layer, based on 100 wt % of the second functional layer. Within the above ranges, the organic component can facilitate formation of the second functional layer without (or substantially without) affecting the function of the second functional layer. The organic component may include at least one of the organic components for the organic layer described above, without being limited thereto. In one embodiment, the organic component may be polyvinylidene fluoride (PVDF).

The second functional layer may further include a conductive material (e.g., an electrically conductive material) described below. The conductive material serves to supplement conductivity (e.g., electrical conductivity) at the positive electrode. The conductive material may include at least one of conductive materials (e.g., electrically conductive materials) described below. In one embodiment, the conductive material may be Ketjen black.

The second functional layer may have a thickness of 1 μm to 5 μm or, for example, 1 μm to 3 μm. Within the above ranges, the second functional layer can improve reliability and stability of batteries through suppression or reduction of a gas side reaction at the positive electrode without (or substantially without) affecting the effects of the organic-inorganic composite layer. In embodiments, the thickness of the second functional layer means a thickness of a region interposed as a mixed layer of the inorganic component and the organic component between the organic-inorganic composite layer and the positive electrode rather than a thickness of a region in which the inorganic component is present alone.

In one embodiment, the first functional layer, the organic-inorganic composite layer and the second functional layer may have a thickness ratio of 1:2 to 5:0.4 to 1.2 or, for example, 1:2 to 4:0.3 to 0.7. Within the above ranges, the above effects can become remarkable.

The negative electrode active material layer may include a carbon-based active material, a silicon-based active material, a tin-based active material, or a combination thereof, as a negative electrode active material.

The carbon-based active material may be crystalline carbon, amorphous carbon, or a combination thereof. Examples of crystalline carbon may include graphite, such as natural and/or artificial graphite that can be amorphous, plate-like, flake-like, spherical, and/or fibrous graphite. Examples of amorphous carbons may include soft carbon, hard carbon, mesoporous pitch carbides, calcined coke, and the like. The silicon-based active material may include Si, Si—C composites, SiOx (0<x<2), and/or Si—Q alloys (where Q is an element selected from the group consisting of alkali metals, alkaline earth metals, group XIII elements, group XIV elements, group XV elements, group XVI elements, transition metals, rare earth elements, and combinations thereof, but not Si). The tin-based active material may include Sn, SnO₂, Sn—R alloys (where R is an element selected from the group consisting of alkali metals, alkaline earth metals, group XIII elements, group XIV elements, group XV elements, group XVI elements, transition metals, rare earth elements, and combinations thereof, but not Sn), and/or mixtures of at least one of these tin-based active materials with SiO₂. In the silicon-based active materials and the tin-based active materials, Q and R may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and combinations thereof.

The negative electrode active material layer may include a negative electrode active material and optionally further include a binder and a conductive material (e.g., an electrically conductive material). The negative electrode active material may be present in an amount of 95 wt % to 99 wt % based on the total weight of the negative electrode active material layer. The binder may be present in an amount of 1 wt % to 5 wt % based on the total weight of the negative electrode active material layer. If the binder and the conductive material are optionally added, the negative electrode active material layer may include 90 wt % to 98 wt % of the negative electrode active material, 1 wt % to 5 wt % of the binder, and 1 wt % to 5 wt % of the conductive material.

The binder serves to bond negative electrode active particles to each other while bonding the negative electrode active material to the current collector. The binder may be a non-aqueous binder, an aqueous binder, or a combination thereof. The non-aqueous binder may be ethylene propylene copolymers, polyacrylonitrile, polystyrene, polyvinyl chloride, carboxylated polyvinyl chloride, polyvinyl fluoride, polyurethane, polytetrafluoroethylene, polyvinylidene fluoride, polyethylene, polypropylene, polyamideimide, polyimide, or a combination thereof. The aqueous binder may be styrene-butadiene rubber (SBR), acrylated styrene-butadiene rubber (ABR), acrylonitrile-butadiene rubber, acrylic rubber, butyl rubber, fluorinated rubber, ethylene oxide-containing polymers, polyvinylpyrrolidone, polypropylene, polyepichlorohydrin, polyphosphazene, ethylene propylene diene copolymer, polyvinylpyridine, chlorosulfonated polyethylene, latex, polyester resin, acrylic resin, phenolic resin, epoxy resin, polyvinyl alcohol, or a combination thereof.

If the aqueous binder is used as the negative electrode binder, a cellulose compound capable of imparting or increasing viscosity may be further added as a thickening agent. The cellulose compound may include a mixture including at least one selected from among carboxymethyl cellulose, hydroxypropylmethyl cellulose, methyl cellulose, and an alkali metal salt thereof. The alkali metal may be Na, K and/or Li. The thickening agent may be present in an amount of 0.1 parts by weight to 3 parts by weight relative to 100 parts by weight of the negative electrode active material.

The conductive material serves to impart conductivity (e.g., electrical conductivity) to the electrodes and may be any suitable electrically conductive material that does not cause chemical change in cells under construction (e.g., does not cause an undesirable chemical change in the cells under construction). Examples of the conductive material may include carbon materials, such as natural graphite, artificial graphite, carbon black, acetylene black, Ketjen black, carbon fiber, and the like; metal-based materials, for example, metal powders and/or metal fibers, such as copper, nickel, aluminum, silver, and the like; conductive polymers (e.g., electrically conductive polymers), such as polyphenylene derivatives and the like; and mixtures thereof.

The current collector may be selected from the group consisting of copper foil, nickel foil, stainless steel foil, titanium foil, nickel foam, copper foam, a polymer substrate coated with a conductive metal (e.g., an electrically conductive metal), and combinations thereof.

The positive electrode includes a current collector and a positive electrode active material layer on the current collector.

The positive electrode active material may be a compound (lithiated intercalation compound) allowing reversible intercalation and deintercalation of lithium. For example, the positive electrode active material may be at least one selected from among composite oxides of a metal selected from among cobalt, manganese, nickel and combinations thereof with lithium. In embodiments, the positive electrode active material may be a compound represented by at least one of the following formulas: LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}CO_{b}X_{c}Dₐ (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}CO_{b}X_{c}O_{2-α}T₂ (0.90≤a≤1.8, 0≤b≤0.5, 0≤c≤0.05, 0<α<2); LiₐNi_{1-b-c}Mn_{b}X_{c}Dₐ (0.90≤a≤1.8, 0≤b≤0.5, 0≤c≤0.05, 0<α≤2); LiₐNi_{1-b-c}Mn_{b}X_{c}O_{2-α}T_{α} (0.90≤a≤1.8, 0≤b≤0.5, 0.5≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂(0.90≤a≤1.8, 0≤b≤0.9, 0≤c≤0.5, 0.001≤d≤0.1); LiₐNi_{b}Co_{c}Mn_{d}GeO₂ (0.90≤a≤1.8, 0≤b≤0.9, 0≤c≤0.5, 0.5≤d≤0.5, 0≤e≤0.1); LiₐNi_{b}Co_{c}Al_{d}GeO₂(0.90≤a≤1.8, 0≤b≤0.9, 0≤c≤0.5, 0≤d≤0.5, 0≤e≤0.1); LiₐNi_{b}Co_{c}Mn_{d}GeO₂ (0.90≤a≤1.8, 0≤b≤0.9, 0≤c≤0.5, 0.5≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0.5≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); and LiₐFePO₄ (0.90≤a≤1.8).

In these formulas, A is selected from the group consisting of Ni, Co, Mn, and combinations thereof; X is selected from the group consisting of Al, Ni, Co, Mn, Cr, Fe, Mg, Sr, V, rare earth elements, and combinations thereof; D is selected from the group consisting of O, F, S, P, and combinations thereof; E is selected from the group consisting of Co, Mn, and combinations thereof; T is selected from the group consisting of F, S, P, and combinations thereof; G is selected from the group consisting of Al, Cr, Mn, Fe, Mg, La, Ce, Sr, V, and combinations thereof; Q is selected from the group consisting of Ti, Mo, Mn, and combinations thereof; Z is selected from the group consisting of Cr, V, Fe, Sc, Y, and combinations thereof; and J is selected from the group consisting of V, Cr, Mn, Co, Ni, Cu, and combinations thereof.

In embodiments, a coating layer may be formed on the surface of the compound or a mixture of the compound and a compound having a coating layer may also be used. The coating layer may include at least one coating element compound selected from the group consisting of an oxide of a coating element, a hydroxide of the coating element, an oxyhydroxide of the coating element, an oxycarbonate of the coating element, and a hydroxycarbonate of the coating element. A compound constituting the coating layer may be non-crystalline or crystalline. The coating element in the coating layer may be Mg, Al, Co, K, Na, Ca, Si, Ti, V, Sn, Ge, Ga, B, As, Zr, or a mixture thereof. The coating layer may be formed using these elements in the compound by any suitable coating method (for example, spray coating, immersion method, and/or the like) that does not (or substantially does not) adversely affect properties of the positive electrode active material. Because such coating methods should be readily recognizable to those skilled in the art upon reviewing this disclosure, further detailed description thereof is not necessary.

In the positive electrode, the positive electrode active material may be present in an amount of 90 wt % to 98 wt % based on the total weight of the positive electrode active material layer. In one embodiment, the positive electrode active material layer may further include a binder and a conductive material (e.g., an electrically conductive material). In embodiments, each of the binder and the conductive material may be present in an amount of 1 wt % to 5 wt % based on the total weight of the positive electrode active material layer.

The binder serves to bond positive electrode active materials to each other while bonding the positive electrode active material to the current collector. Examples of the binder may include polyvinyl alcohol, carboxymethylcellulose, hydroxypropylcellulose, diacetylcellulose, polyvinyl chloride, carboxylated polyvinyl chloride, polyvinyl fluoride, ethylene oxide-containing polymers, polyvinylpyrrolidone, polyurethane, polytetrafluoroethylene, polyvinylidene fluoride, polyethylene, polypropylene, styrene-butadiene rubber, acrylated styrene-butadiene rubber, epoxy resins, nylon, and the like, without being limited thereto.

The conductive material serves to impart conductivity (e.g., electrical conductivity) to the electrodes and may be any suitable electrically conductive material that does not cause chemical change in cells under construction (e.g., does not cause an undesirable chemical change in the cells under construction). Examples of the conductive material may include carbon materials, such as natural graphite, artificial graphite, carbon black, acetylene black, Ketjen black, carbon fiber, and the like; metal-based materials, for example, metal powders and/or metal fibers, such as copper, nickel, aluminum, silver, and the like; conductive polymers (e.g., electrically conductive polymers), such as polyphenylene derivatives and the like; and mixtures thereof.

The current collector may employ Al, without being limited thereto.

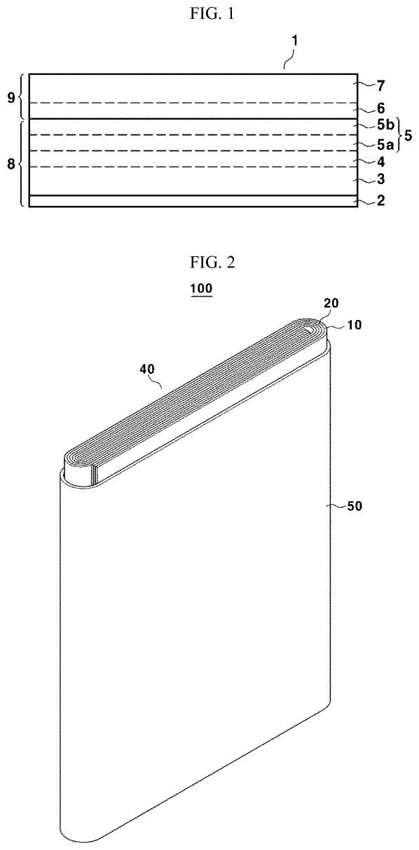

Referring to FIG. 1, an electrode assembly 1 according to one embodiment of the disclosure includes a negative electrode 8 and a positive electrode 9, in which the negative electrode 8 includes a current collector 2, a negative electrode active material layer 3, a first functional layer 4, and an organic-inorganic composite layer 5; and the positive electrode 9 includes a second functional layer 6 and a composite 7 of a positive electrode active material layer and a current collector. The organic-inorganic composite layer 5 includes a first layer 5a and a second layer 5b. If the first layer 5a is an organic layer, the second layer 5b may be an inorganic layer, and if the first layer 5a is an inorganic layer, the second layer 5b may be an organic layer.

Although the first functional layer 4 and the negative electrode active material layer 3 are shown as separate layers in FIG. 1, this structure is shown for illustration of the negative electrode material layer and the first functional layer and a dotted line shows that the negative electrode active material layer is integrated with the first functional layer. In FIG. 1, the first layer 5a and the second layer 5b partially spread into each other to form a composite layer, which is also represented by a dotted line. In embodiments, although the first functional layer 4 and the organic-inorganic composite layer 5 are shown as separate layers, this structure is shown for illustration of the first functional layer and the organic-inorganic composite layer, and a dotted line shows that the first functional layer is integrated with the organic-inorganic composite layer. In embodiments, although the second functional layer 6 and the composite 7 of the positive electrode active material layer and the current collector are shown as separate layers, this structure is shown for illustration of the second functional layer 6 and the composite 7 of the positive electrode active material layer and the current collector, and a dotted line shows that the second functional layer is integrated with the composite 7 of the positive electrode active material layer and the current collector.

In the electrode assembly according to one embodiment, because the negative electrode material layer is integrated with the first functional layer and the second functional layer, the negative electrode active material layer may have substantially the same size as the organic-inorganic composite layer in a thickness direction thereof.

### Method of Manufacturing Electrode Assembly for Rechargeable Lithium Batteries

The electrode assembly may be manufactured by the following method.

(1) A negative electrode active material layer is provided on a current collector. The negative electrode active material layer may be formed by a typical method in which a negative electrode active material, a binder, and optionally a conductive material (e.g., an electrically conductive material) are mixed together in a solvent to prepare a slurry-type negative electrode active material composition, which in turn is applied to and dried on the current collector.

(2) Next, a negative electrode is prepared by forming a first functional layer on the negative electrode active material active layer.

The first functional layer may be formed by depositing a composition for the first functional layer to a set or predetermined thickness on the negative electrode active material layer, followed by drying the composition. In embodiments, the composition for the first functional layer includes an inorganic component alone or a mixture of an inorganic component and an organic component. The composition for the first functional layer may further include a solvent. The solvent may be dimethylacetate, N-methylpyrrolidone, dimethylformamide, acetone, or a combination thereof.

An organic-inorganic composite layer is provided on the first functional layer. Upon formation of the organic-inorganic composite layer, an organic layer and an inorganic layer may be formed in any sequence.

In one embodiment, the organic layer may be formed by electrospinning a composition for the organic layer on a target matrix. The composition for the organic layer may include a polymer and a solvent.

For electrospinning, a nozzle pack including tips each having a hole size of 23G (gauge) to 30G and a collector roller are placed with a set or predetermined interval therebetween, and the composition for the organic layer is provided to the tips. Then, with a target matrix placed above the collector roller, electrospinning may be performed by applying a voltage of 35 kV to 50 kV to the tips. The number of tips may be suitably adjusted depending on the type (or kind), content, and/or the like of polymers included in the composition for the organic layer, and may be set in the range of, for example, 20 to 60. A distance between the nozzle pack and the target matrix may be set in the range of 10 cm to 20 cm. If the tips have a hole size of 25G to 30G, the organic layer can be efficiently formed in a suitable or desired shape.

In the electrospinning process, a polymer solution may be sprayed and stretched into fiber form, which in turn is spun on the target matrix in the form of a cone, thereby forming the organic layer. In embodiments, the composition for the organic layer is suspended from the tips in the form of a droplet due to surface tension thereof. Then, if voltage is applied, a repulsive force of charges causes the droplet to twist in an opposite direction to surface tension of the polymer solution, and if a critical voltage is reached, the polymer solution is ejected from an apex of the droplet such that jets, called a Taylor cone, are collected on the collector roller to form the organic layer.

Electrospinning may be performed at 20° C. to 30° C. under conditions of 40% RH to 60% RH. If electrospinning is performed under the above conditions, it is possible to maintain the thickness of fibers during electrospinning.

The rolling speed of the collector roller may be adjusted to allow the organic layer to be formed to a suitable thickness. For example, the rolling speed of the collector roller may be adjusted to 1 m/min to 3 m/min. Furthermore, the composition for the organic layer may be discharged from the tips at a discharge rate of 20 μl/min to 200 μl/min in terms of solid content.

Tip air is suitably adjusted in order to secure uniform (or substantially uniform) electrospinning through minimization or reduction of interference between the tips. The tip air may be adjusted by supplying compressed air at a pressure of 0.1 MPa to 0.2 MPa.

After electrospinning is completed, drying is performed utilizing hot air at 70° C. to 110° C.

In the composition for the organic layer, the polymer may be a mixture of one or more of the aforementioned polymers and the solvent may be dimethyl acetate, dimethylformamide, acetone, or a combination thereof.

As the polymer, the aforementioned heat-resistant polymers may be used and, because these heat-resistant polymers are non-aqueous, the organic solvent is used as the solvent. Accordingly, if an aqueous polymer is used, a water-based solvent must be used. However, the water-based solvent does not allow easy electrospinning and can cause damage to the electrodes such as, for example, a spring back problem. According to the embodiments of the disclosure, the organic solvent is used, thereby preventing or reducing a likelihood or occurrence such a problem.

The polymer may be present in an amount of 5 wt % to 20 wt % based on 100 wt % of the composition for the organic layer. Within the range of the amount of the polymer, the organic layer can be formed to a suitable thickness. If the polymer content is less than 5 wt %, electrospinning can have difficulty forming fibers, and if the polymer content is higher than 20 wt %, the tips can be blocked upon electrospinning, making it difficult to spin the composition, or the fibers can become uneven in thickness and can be spun coarsely.

As the organic layer is formed by electrospinning, the organic layer can have a woven state, for example, a network structure. If the organic layer is formed by a direct coating process or a process of dipping the target matrix in the composition instead of electrospinning, the organic layer can be densely formed and a pole plate can be excessively thickened due to solvent residue on the pole plate, thereby making it difficult to achieve a suitable increase in energy density per cell volume. Further, a densely formed organic layer itself acts as a resistant layer and thus can suffer from an increase in resistance to migration of Li ions, thereby causing deterioration in cell performance. In embodiments, if the organic layer is formed by electrospinning, the solvent can be efficiently volatilized, thereby more efficiently suppressing or reducing the spring back phenomenon in which the solvent damages the negative electrode.

The inorganic layer may be formed by electrospinning a composition for the inorganic layer on a target matrix. The composition for the inorganic layer may include a polymer and a solvent.

For electrospinning, a nozzle pack including tips each having a hole size of 23G to 30G and a collector roller are placed with a set or predetermined interval therebetween, and the composition for the inorganic layer is provided to the tips. Then, with a target matrix placed above the collector roller, electrospinning may be performed by applying a voltage of 35 kV to 50 kV to the tips.

The number of tips may be suitably adjusted depending on the type (or kind), content, and/or the like of polymers included in the composition for the inorganic layer, and may be set in the range of, for example, 20 to 60. A distance between the nozzle pack and the target matrix may be set in the range of 10 cm to 20 cm. If the tips have a hole size of 25G to 30G, the inorganic layer can be efficiently formed in a suitable or desired shape. In the electrospinning process, the composition for the inorganic layer may be sprayed in dot form to form the inorganic layer on the target matrix. If the inorganic layer is formed by a direct coating process or a process of dipping the target matrix in the composition instead of electrospinning, the pole plate can be excessively thickened due to solvent residue on the pole plate, thereby making it difficult to achieve a suitable increase in energy density per cell volume. As the inorganic layer is formed by electrospinning, the solvent can be efficiently volatilized, thereby more efficiently suppressing or reducing the spring back phenomenon in which the solvent damages the negative electrode. The rolling speed of the collector roller may be adjusted to allow the inorganic layer to be formed to a suitable thickness. For example, the rolling speed of the collector roller may be adjusted to 0.5 m/min to 3.0 m/min. Furthermore, the composition for the organic layer may be discharged from the tips at a discharge rate of 20 μl/min to 100 μl/min in terms of solid content. Tip air is suitably adjusted in order to secure uniform (or substantially uniform) electrospinning through minimization or reduction of interference between the tips. The tip air may be adjusted by supplying compressed air at a pressure of 0.1 MPa to 0.2 MPa. After electrospinning is completed, drying is performed utilizing hot air at 90° C. to 110° C.

The composition for the inorganic layer include the same inorganic components as described above, and the solvent may be distilled water, an alcohol such as ethanol, dimethyl acetate, N-methyl pyrrolidone, dimethyl formamide, acetone, or a combination thereof. The binder may be polyvinylidene fluoride, polyamideimide, polyvinylpyrrolidone, polyacrylonitrile, polyacrylic acid, a copolymer thereof, or a combination thereof. The inorganic component may be present in an amount of 85 wt % to 96 wt % based on 100 wt % of the composition for the inorganic layer.

After formation of the organic-inorganic composite layer, roll pressing may be further performed. Roll pressing may be performed at 25° C. to 110° C. By the roll pressing process, a migration path of Li ions can be reduced in the organic-inorganic composite layer, thereby enabling efficient migration of the Li ions.

As such, upon electrospinning the composition for the organic layer, the composition for the organic layer spreads into spaces between pores naturally formed in the negative electrode active material layer and is integrated therewith to form the organic layer in a woven state, for example, in a network structure, and the composition for the inorganic layer spreads into the pores to form the organic-inorganic layer, whereby the organic-inorganic layer can be integrated with the negative electrode active material layer.

In embodiments, even if the inorganic layer is formed prior to the organic layer, the composition for the inorganic layer spreads into the pores naturally formed in the negative electrode active material layer and is integrated therewith, and the composition for the organic layer spreads into the inorganic layer upon electrospinning, whereby the organic-inorganic layer can be integrated with the negative electrode active material layer.

In embodiments, such integration can be more effectively achieved by roll pressing.

(3) Next, a positive electrode is provided by providing a second functional layer on a positive electrode active material layer.

The positive electrode active material layer may be formed by any suitable method generally used in the art.

Thereafter, the second functional layer is provided on the positive electrode active material layer.

The second functional layer may be provided by depositing a composition for the second functional layer to a set or predetermined thickness on the positive electrode active material layer, followed by drying the composition for the second functional layer. Here, the composition for the second functional layer includes an inorganic component alone, or a mixture of an inorganic component and an organic component, or a mixture of an inorganic component, an organic component or a conductive material (e.g., an electrically conductive material). The composition for the second functional layer may further include a solvent. The solvent may be dimethylacetate, N-methylpyrrolidone, dimethylformamide, acetone, or a combination thereof.

(4) Next, an electrode assembly is manufactured by placing the negative electrode and the positive electrode in contact with each other. Here, the second functional layer of the positive electrode and the organic-inorganic composite layer of the negative electrode are placed in contact with each other.

### Rechargeable Lithium Battery

Another aspect of embodiments of the present disclosure provides a rechargeable lithium battery that includes the electrode assembly and an electrolyte.

The electrolyte includes a non-aqueous organic solvent and a lithium salt. The non-aqueous organic solvent acts as a medium through which ions involved in electrochemical reaction in a cell can migrate. The non-aqueous organic solvent may be a carbonate-based solvent, an ester-based solvent, an ether-based solvent, a ketone-based solvent, an alcohol-based solvent, and/or a non-amphoteric solvent. The carbonate-based solvent may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone and/or the like. The alcohol-based solvent may include ethyl alcohol, isopropyl alcohol, and/or the like, and the non-amphoteric solvent may include nitriles, such as R—CN (where R is a straight, branched or cyclic C₂ to C₂₀ hydrocarbon group and may include a double bond aromatic ring and/or an ether bond), amides such as dimethylformamide and/or the like, dioxolanes, such as 1,3-dioxolane and/or the like, sulfolanes, and/or the like.

The organic solvent may be used alone or as a mixture thereof, and if used as a mixture thereof, the mixing proportion of the mixture may be suitably adjusted according to intended cell performance, as will be readily understood by those skilled in the art upon reviewing this disclosure.

In embodiments, the carbonate-based solvent may be a mixture of a cyclic carbonate and a chain carbonate. The cyclic carbonate and the chain carbonate may be mixed together in a volume ratio of 1:1 to 1:9 in order to secure good electrolyte performance.

The organic solvent may further include an aromatic hydrocarbon-based organic solvent in addition to the carbonate-based solvent. The carbonate-based solvent and the aromatic hydrocarbon-based organic solvent may be mixed together in a volume ratio of 1:1 to 30:1.

The aromatic hydrocarbon-based organic solvent may be a hydrocarbon compound represented by Formula 1:

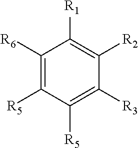

where R₁ to R₆ are the same or different from each other and may be selected from the group consisting of hydrogen, a halogen, a C₁ to C₁₁ alkyl group, a haloalkyl group, and combinations thereof.

In embodiments, the aromatic hydrocarbon-based organic solvent may be selected from among benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof.

As a lifespan-enhancing additive to improve cell life, the electrolyte may further include vinylene carbonate and/or an ethylene carbonate-based compound represented by Formula 2:

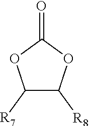

where R₇ and R₈ are the same or different from each other and may be selected from the group consisting of hydrogen, a halogen group, a cyano group (CN), a nitro group (NO₂), and a fluorinated C₁ to C₅ alkyl group (at least one of R₇ and R₈ being selected from the group consisting of a halogen group, a cyano group (CN), a nitro group (NO₂), and a fluorinated C₁ to C₅ alkyl group, provided that both R₇ and R₈ are not hydrogen.

Examples of the ethylene carbonate-based compound may include difluoroethylene carbonate, chloroethylene carbonate, dichloroethylene carbonate, bromoethylene carbonate, dibromoethylene carbonate, nitroethylene carbonate, cyanoethylene carbonate and/or fluoroethylene carbonate. The amount of such a lifespan-enhancing additive may be suitably adjusted, as needed or desired.

The lithium salt is a substance that is soluble in an organic solvent and acts as a source of lithium ions within a cell to allow basic operation of the rechargeable lithium battery while facilitating migration of lithium ions between the positive electrode and the negative electrode. The lithium salt may include at least one selected from the group consisting of LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers, for example, an integer in the range of 1 to 20), LiCl, Lil, and LiB(C₂O₄)₂ (lithium bis(oxalato) borate: LiBOB) as a supporting electrolyte salt. The lithium salt is preferably used within the range of 0.1 M to 2.0 M. Within the above range of the lithium salt, the electrolyte has suitable conductivity (e.g., electrical conductivity) and viscosity, thereby securing good electrolyte performance and effective migration of lithium ions.

A separator may be present between the positive electrode and the negative electrode depending upon the kind of rechargeable lithium battery. The separator may be a polyethylene separator, a polypropylene separator, a polyvinylidene fluoride separator, a multilayer separator thereof, or a combined multilayer separator, such as a polyethylene/polypropylene bilayer separator, a polyethylene/polypropylene/polyethylene trilayer separator, a polypropylene/polyethylene/polypropylene trilayer separator, and/or the like.

FIG. 2 is a perspective view of a rechargeable lithium battery according to one embodiment of the present disclosure. Although the rechargeable lithium battery according to this embodiment is illustrated as a prismatic battery by way of example, it should be understood that the present disclosure is not limited thereto and may be applied to various suitable types (or kinds) of batteries, such as a cylinder type (or kind), a pouch type (or kind), and/or the like.

Referring to FIG. 2, the rechargeable lithium battery 100 according to this embodiment may include an electrode assembly 40 having a positive electrode 10 and a negative electrode 20 wound into a roll therein, and a case 50 in which the electrode assembly 40 is housed. The positive electrode 10 and the negative electrode 20 may be embedded in an electrolyte. The rechargeable lithium battery 100 does not include a separator used in other rechargeable lithium batteries.

Next, embodiments of the present disclosure will be described in more detail with reference to some examples. It should be understood that these examples are provided for illustration only and are not to be construed in any way as limiting the present disclosure.

### Example 1

A negative electrode active material slurry was prepared by mixing together 97.5 wt % of artificial graphite, 1.0 wt % of carboxymethyl cellulose, and 1.5 wt % of styrene butadiene rubber (SBR) in a water-based solvent. The negative electrode active material slurry was applied to a copper current collector, dried, and rolled to form a negative electrode active material layer.

A composition for a first functional layer was prepared by mixing together 95 wt % of lithium titanium oxide (LTO, average grain size (D50): 1.5 μm), 5 wt % of polyvinylidene fluoride, and a solvent (N-methylpyrrolidone). The first functional layer was formed by depositing the composition for the first functional layer to a predetermined thickness on the negative electrode active material layer, followed by drying the composition at 90° C.

An organic layer was formed by electrospinning a composition for the organic layer, which includes 70 wt % of polyvinylidene fluoride, 30 wt % of polyacrylonitrile and a solvent (dimethyl acetate), on the first functional layer. Electrospinning was performed by the following method.

A nozzle pack including 52 tips each having a hole size of 25G and a collector roller were placed with a predetermined interval of 15 cm therebetween and the composition for the organic layer was provided to the tips. Then, electrospinning was performed under conditions of 26° C. and 50% RH by applying a voltage of 40 kV to 50 kV to the tips. Here, the rolling speed of the collector roller was adjusted to 1 m/min to 3 m/min and the composition for the organic layer was discharged from the tips at a discharge rate of 150 μl/min in terms of solid content. During electrospinning, compressed air was supplied at a pressure of 0.1 MPa. After electrospinning was completed, the spun composition was dried utilizing hot air at 90° C. The organic layer formed by electrospinning had a thickness of 5 μm.

Next, an inorganic layer was formed by electrospinning a composition for the inorganic layer, which was prepared by mixing boehmite (average particle diameter (D50): 350 nm) and polyacrylic acid (PAA) in a weight ratio of 20:1 in a mixed solvent of distilled water and ethanol (volume ratio of 1:1), onto the organic layer. Electrospinning was performed by the following method.

A nozzle pack with 52 tips each having a hole size of 25G and a collector roller were placed with a predetermined interval of 15 cm therebetween, and the composition for the inorganic layer was provided to the tips. Then, electrospinning was performed under conditions of 26° C. and 50% RH by applying a voltage of 40 kV to 50 kV to the tips. Here, the rolling speed of the collector roller was adjusted to 1.5 m/min and the composition for the inorganic layer was discharged from the tips at a discharge rate of 100 μl/min in terms of solid content. During electrospinning, compressed air was supplied at a pressure of 0.1 MPa. After electrospinning was completed, the spun composition was dried utilizing hot air at 90° C. The inorganic layer formed by electrospinning had a thickness of 6 μm.

A negative electrode was formed through integration of the first functional layer and the organic-inorganic composite layer (thickness: 11 μm) of the organic layer and the inorganic layer with the negative electrode active material layer by the above processes.

A positive electrode active material slurry was prepared by mixing together 96 wt % of LiCoO₂, 2 wt % of Ketjen black and 2 wt % of polyvinylidene fluoride in a solvent (N-methyl pyrrolidone). A positive electrode active material layer was formed by depositing, drying and pressing the positive electrode active material slurry on the Al current collector.

A composition for a second functional layer was prepared by mixing together 95 wt % of lithium ferrophosphate (LFP) (average particle diameter (D50): 1 μm), 3 wt % of polyvinylidene fluoride and 2 wt % of Ketjen black in a solvent (N-methyl pyrrolidone).

A positive electrode was formed through formation of a second functional layer by depositing the composition for the second functional layer to a predetermined thickness on the positive electrode active material layer, followed by drying the composition at 90° C.

An electrode assembly was prepared by stacking the negative electrode and the positive electrode to contact each other. Here, the organic-inorganic composite layer of the negative electrode and the second functional layer of the positive electrode were placed to contact each other. The electrode assembly and an electrolyte were used to prepare a rechargeable lithium battery (without a separator). The electrolyte was a mixed solvent of ethylene carbonate and ethyl methyl carbonate (50:50 in volume ratio), in which LiPF₆ was dissolved.

### Example 2

A rechargeable lithium battery was prepared in the same manner as in Example 1 except that the organic-inorganic composite layer was formed to a thickness of 8 μm by changing the thickness of each of the organic layer and the inorganic layer.

### Examples 3 to 5

Rechargeable lithium batteries were prepared in the same manner as in Example 1 except that the thickness of each of the first functional layer and the second functional layer was changed.

### Comparative Examples 1-1 and 1-2

A negative electrode active material slurry and a negative electrode active material layer were prepared in the same manner as in Example 1. An organic layer was formed on the negative electrode active material layer by preparing and electrospinning a composition for the organic layer in the same manner as in Example 1. Next, an inorganic layer was formed on the organic layer by preparing and electrospinning a composition for the inorganic layer in the same manner as in Example 1, thereby preparing a negative electrode in which an organic-inorganic composite layer of the organic layer and the inorganic layer is integrated with the negative electrode active material layer.

A positive electrode active material slurry, a positive electrode active material layer, and a positive electrode were prepared in the same manner as in Example 1. An electrode assembly was prepared by stacking the negative electrode and the positive electrode to contact each other. Here, the organic-inorganic composite layer of the negative electrode and the positive electrode active material layer of the positive electrode were placed to contact each other. The electrode assembly and an electrolyte were used to prepare a rechargeable lithium battery (without a separator). The electrolyte was the same as the electrolyte used in Example 1. In Comparative Example 1-1, the organic-inorganic composite layer had a thickness of 11 μm and, in Comparative Example 1-2, the organic-inorganic composite layer had a thickness of 8 μm.

### Comparative Examples 2-1 and 2-2

A negative electrode active material slurry and a negative electrode active material layer were prepared in the same manner as in Example 1. An organic layer was formed on the negative electrode active material layer by preparing and electrospinning a composition for the organic layer in the same manner as in Example 1. Next, an inorganic layer was formed on the organic layer by preparing and electrospinning a composition for the inorganic layer in the same manner as in Example 1, thereby preparing a negative electrode in which an organic-inorganic composite layer of the organic layer and the inorganic layer is integrated with the negative electrode material layer.

A positive electrode active material layer was formed in the same manner as in Example 1.

A positive electrode was prepared by preparing a composition for a second functional layer in the same manner as in Example 1, followed by forming the second functional layer on the positive electrode active material layer using the composition.

An electrode assembly was prepared by stacking the negative electrode and the positive electrode to contact each other. Here, the organic-inorganic composite layer of the negative electrode and the second functional layer of the positive electrode were placed to contact each other. The electrode assembly and an electrolyte were used to prepare a rechargeable lithium battery (without a separator). The electrolyte was the same as the electrolyte used in Example 1. In Comparative Example 2-1, the organic-inorganic composite layer had a thickness of 11 μm and, in Comparative Example 2-2, the organic-inorganic composite layer had a thickness of 8 μm.

### Comparative Examples 3-1 and 3-2

A negative electrode active material slurry and a negative electrode active material layer were prepared in the same manner as in Example 1. A first functional layer was formed on the negative electrode active material layer by electrospinning a composition for the first function layer in the same manner as in Example 1. An organic layer was formed on the first functional layer by preparing and electrospinning a composition for the organic layer in the same manner as in Example 1. Next, an inorganic layer was formed on the organic layer by preparing and electrospinning a composition for the inorganic layer in the same manner as in Example 1, thereby preparing a negative electrode including the first functional layer and an organic-inorganic composite layer of the organic layer and the inorganic layer.

A positive electrode was prepared by forming a positive electrode active material layer in the same manner as in Example 1.

An electrode assembly was prepared by stacking the negative electrode and the positive electrode to contact each other. Here, the first functional layer of the negative electrode and the positive electrode active material layer of the positive electrode were placed to contact each other. The electrode assembly and an electrolyte were used to prepare a rechargeable lithium battery (without a separator). The electrolyte was the same as the electrolyte used in Example 1. In Comparative Example 3-1, the organic-inorganic composite layer had a thickness of 11 μm and, in Comparative Example 3-2, the organic-inorganic composite layer had a thickness of 8 μm.

### Comparative Examples 4-1 and 4-2

A negative electrode active material slurry and a negative electrode active material layer were prepared in the same manner as in Example 1. A negative electrode was prepared by forming a first functional layer using a composition for the first functional layer in the same manner as in Example 1.

A positive electrode active material layer was formed in the same manner as in Example 1. A negative electrode was prepared by forming a second functional layer using a composition for the second functional layer in the same manner as in Example 1.

An electrode assembly was prepared by stacking the positive electrode, a polyethylene separator, and the positive electrode, followed by pressing at 90° C. under a 270 kg load for 10 seconds. A rechargeable lithium battery was manufactured using the electrode assembly and an electrolyte. The electrolyte was the same as the electrolyte used in Example 1. In Comparative Example 4-1, the separator had a thickness of 11 μm and, in Comparative Example 4-2, the separator had a thickness of 8 μm.

### Reference Example 1

A negative electrode active material slurry and a negative electrode active material layer were prepared in the same manner as in Example 1. An organic layer was formed by preparing and electrospinning a composition for the organic layer in the same manner as in Example 1. Next, an inorganic layer was formed by preparing and electrospinning a composition for the inorganic layer in the same manner as in Example 1, thereby preparing a negative electrode in which an organic-inorganic composite layer of the organic layer and the inorganic layer is integrated with the negative electrode active material layer.

A positive electrode active material slurry, a positive electrode active material layer, and a positive electrode were prepared in the same manner as in Example 1. An electrode assembly was prepared by stacking the negative electrode and the positive electrode to contact each other. Here, the organic-inorganic composite layer of the negative electrode and the positive electrode active material layer of the positive electrode were placed to contact each other. The electrode assembly and an electrolyte were used to prepare a rechargeable lithium battery (without a separator). The electrolyte was the same as the electrolyte used in Example 1. The organic-inorganic composite layer had a thickness of 14 μm.

### Experimental Example 1: Evaluation of capacity

A rechargeable lithium battery was charged with a constant current of 0.2 C at a cut-off voltage of 4.25 V at 25° C. and maintained at a constant voltage of 4.4 V until the current reached 0.025 C, followed by discharging at a constant current of 0.2 C until the voltage reached 2.8 V. The presence or absence of lithium dendrites during this charge/discharge process was evaluated and results are shown in Table 1. For batteries with no lithium dendrites, charge/discharge capacity (unit: mAh) was measured and results thereof are shown in Table 2.

TABLE 1

| | Thickness of | Thickness | | |
|---|---|---|---|---|
| | organic-inorganic | of | Thickness | Generation |
| | composite layer | first | of first | of |
| | (or separator) | functional | functional | lithium |
| | (μm) | layer (μm) | layer (μm) | dendrites |
| Example 1 | 11 | 3 | 2 | Not generated |
| Example 2 | 8 | 3 | 2 | Not generated |
| Example 3 | 11 | 3 | 1 | Not generated |
| Example 4 | 11 | 5 | 2 | Not generated |
| Example 5 | 11 | 5 | 3 | Not generated |
| Comparative | 11 | — | — | Generated |
| Example 1-1 | | | | |
| Comparative | 8 | — | — | Generated |
| Example 1-2 | | | | |
| Comparative | 11 | — | 2 | Generated |
| Example 2-1 | | | | |
| Comparative | 8 | — | 2 | Generated |
| Example 2-2 | | | | |
| Comparative | 11 | 3 | — | Not generated |
| Example 3-1 | | | | |
| Comparative | 8 | 3 | — | Not generated |
| Example 3-2 | | | | |
| Comparative | 11 | 3 | 2 | Not generated |
| Example 4-1 | | | | |
| Comparative | 8 | 3 | 2 | Not generated |
| Example 4-2 | | | | |
| Reference | 14 | — | — | Not generated |
| Example 1 | | | | |

As shown in Table 1, it could be seen from Reference Example 1 that, when the organic-inorganic composite layer had a thickness of 14 μm, lithium dendrites were not formed. However, from Comparative Examples 1-1 and 1-2, it could be seen that, if the organic-inorganic composite layer had a thickness of less than 14 μm, lithium dendrites were formed. In addition, from Comparative Examples 2-1 and 2-2, it could be seen that, if the organic-inorganic composite layer had a thickness of less than 14 μm and the second functional layer was formed alone, lithium dendrites were still present. Conversely, from Comparative Examples 3-1 and 3-2, it could be seen that, even if the organic-inorganic composite layer had a thickness of less than 14 μm, lithium dendrites were not generated due to formation of the first functional layer or the presence of the separator instead of the organic-inorganic composite layer as in Comparative Examples 4-1 and 4-2.

The following evaluation was carried out with respect to Examples 1 to 5 and Comparative Examples 3 to 4 in which lithium dendrites were not formed.

### Experimental Example 2: Evaluation of Battery Characteristics

The following properties were evaluated as to rechargeable lithium batteries not suffering from generation of lithium dendrites during evaluation of charge/discharge capacity. Results thereof are shown in Table 2.
(1) Processability: Upon winding a rechargeable lithium battery into a roll, a sample with no curl was rated as ⊚, a usable sample despite slight curls was rated as ∘, and an unusable sample due to excessive curls was rated as X.
(2) Resistance: A rechargeable lithium battery was charged to SOC 50% at 0.2 C and discharged by 1 C for 10 sec to evaluate DC-IR. A resistance of less than 35 mΩ was rated as ⊚, a resistance of 35 mΩ to less than 38 mΩ was rated as ∘, a resistance of 38 mΩ to less than 43 mΩ was rated as A, and a resistance of 43 mΩ or more was rated as x.
(3) Lifespan at room temperature: In a chamber at 25° C., a rechargeable lithium battery was repeatedly charged and discharged 300 times under condition of charge to 4.25 V at 0.5 C (cut-off: 0.02 C) and discharge to 2.8 V at 0.5 C. A capacity retention rate of 90% or more was rated as ∘, a capacity retention rate of 80% to less than 90% was rated as Δ, and a capacity retention rate of less than 80% was rated as x. Here, the capacity retention rate was defined as the ratio of capacity at the 300^{th} charge/discharge operation to capacity at the 1^{st} charge/discharge operation.
(4) High-temperature storage: A rechargeable lithium battery was fully charged at 25° C. by charging to 4.25 V with a constant current of 0.5 C, followed by 0.02 C cutoff while maintaining 4.25 V in a constant voltage mode. The fully charged battery was left in a chamber at 60° C. for one month. Then, recovery capacity was measured. The recovery capacity was defined as the ratio of capacity after one month of storage at 60° C. to capacity before storage. A recovery capacity of 95% or more was rated as ⊚, a recovery capacity of 90% to less than 95% was rated as ∘, a recovery capacity of 80% to less than 90% was rated as Δ, and a recovery capacity of less than 80% was rated as X.
(5) Heat exposure: A rechargeable lithium battery was fully charged at 25° C. by charging to 4.25 V with a constant current of 0.5 C, followed by 0.02 C cutoff while maintaining 4.25 V in a constant voltage mode. The fully charged battery was left at 150° C. for 1 hour while raising the temperature at 5° C./min. Heat exposure was evaluated with respect to 5 samples of each of the Examples and Comparative Examples. After the battery was maintained at 150° C. for 1 hour, the battery was decomposed to obtain a sample of the first functional layer/organic-inorganic composite layer/second functional layer (or first functional layer/organic-inorganic composite layer or first functional layer/separator/second functional layer) and shrinkage of the sample in the width direction was checked. If each sample was maintained at 150° C. for 1 hour, no shrinkage of 5 samples was rated as ⊚, shrinkage of 1 or 2 samples was rated as ∘, shrinkage of 3 or more samples was rated as Δ, and cell ignition was rated as X.
(6) Penetration testing: A rechargeable lithium battery was fully charged at 25° C. by charging to 4.25 V with a constant current of 0.5 C, followed by 0.02 C cutoff while maintaining 4.25 V in a constant voltage mode. Then, the rechargeable lithium battery was penetrated with a 3φ nail at a rate of 150 mm/sec. Penetration testing was performed with respect to 5 samples of each of the Examples and Comparative Examples. No penetration of 5 samples was rated as ⊚, penetration of 1 or 2 samples was rated as ∘, penetration of 3 to 4 samples was rated as Δ, and penetration of 5 samples was rated as X.

TABLE 2

| | Charge/ | | | Lifespan | High- | | |
|---|---|---|---|---|---|---|---|
| | discharge | | | at room | temperature | Heat | |
| | capacity | Processability | Resistance | temperature | storage | exposure | Penetration |
| Example 1 | 1982 | ⊚ | Δ | Δ | ⊚ | ⊚ | ⊚ |
| Example 2 | 1985 | ⊚ | ◯ | ◯ | ⊚ | ⊚ | ⊚ |
| Example 3 | 1982 | ⊚ | Δ | ◯ | Δ | ⊚ | ◯ |
| Example 4 | 1974 | ⊚ | Δ | Δ | ⊚ | ⊚ | ⊚ |
| Example 5 | 1966 | ⊚ | Δ | Δ | ⊚ | ⊚ | ⊚ |
| Comparative | 1988 | ⊚ | ◯ | Δ | X | Δ | X |
| Example 3-1 | | | | | | | |
| Comparative | 1990 | ⊚ | ⊚ | ◯ | X | Δ | X |
| Example 3-2 | | | | | | | |
| Comparative | 1973 | ◯ | X | X | Δ | Δ | Δ |
| Example 4-1 | | | | | | | |
| Comparative | 1976 | X | X | Δ | Δ | X | X |
| Example 4-2 | | | | | | | |

As shown in Table 2, the lithium ion batteries of Examples 1 to 5 exhibited good properties in terms of processability, lifespan, high-temperature storage, penetration and heat exposure. Conversely, the lithium ion batteries of Comparative Examples 3-1, 3-2, 4-1 and 4-2 failed to provide all effects of the lithium ion batteries of Examples 1 to 5.

Although the subject matter of the present disclosure has been described with reference to some example embodiments, it should be understood by those skilled in the art that these embodiments are given by way of illustration only, and that various modifications, variations and alterations can be made without departing from the spirit and scope of the disclosure. Therefore, the scope of the present disclosure should be limited only by the accompanying claims and equivalents thereto.

What is claimed is:

1. An electrode assembly for a rechargeable lithium battery, the electrode assembly comprising a negative electrode and a positive electrode,
wherein the negative electrode comprises a current collector; a negative electrode active material layer on the current collector and comprising a negative electrode active material; and a first functional layer and an organic-inorganic composite layer sequentially on the negative electrode active material layer, the first functional layer being integrated with the negative electrode active material layer, and
wherein the positive electrode comprises a second functional layer facing the organic-inorganic composite layer.

2. The electrode assembly for rechargeable lithium batteries as claimed in claim 1, wherein the organic-inorganic composite layer is integrated with the first functional layer.

3. The electrode assembly for rechargeable lithium batteries as claimed in claim 1, wherein the organic-inorganic composite layer is integrated with the second functional layer.

4. The electrode assembly for rechargeable lithium batteries as claimed in claim 1, wherein the organic-inorganic composite layer has a thickness of less than 14 μm.

5. The electrode assembly for rechargeable lithium batteries as claimed in claim 1, wherein the first functional layer, the organic-inorganic composite layer and the second functional layer have a thickness ratio of 1:2 to 5:0.4 to 1.2.

6. The electrode assembly for rechargeable lithium batteries as claimed in claim 1, wherein the first functional layer is an inorganic layer comprising an inorganic component.

7. The electrode assembly for rechargeable lithium batteries as claimed in claim 6, wherein the inorganic component comprises at least one selected from among lithium titanium oxide (LTO), silicon oxide (SiOx), and silicon carbon nanocomposite (SCN).

8. The electrode assembly for rechargeable lithium batteries as claimed in claim 1, wherein the second functional layer comprises an inorganic layer comprising an inorganic component.

9. The electrode assembly for rechargeable lithium batteries as claimed in claim 8, wherein the inorganic component comprises lithium ferrophosphate (LFP).

10. The electrode assembly for rechargeable lithium batteries as claimed in claim 1, wherein the first functional layer has a thickness of 1 μm to 5 μm and the second functional layer has a thickness of 1 μm to 5 μm.

11. The electrode assembly for rechargeable lithium batteries as claimed in claim 1, wherein the organic-inorganic composite layer comprises an organic layer and an inorganic layer integrated with each other.

12. The electrode assembly for rechargeable lithium batteries as claimed in claim 11, wherein the organic layer has a woven state or a non-woven state.

13. The electrode assembly for rechargeable lithium batteries as claimed in claim 11, wherein the organic layer comprises a polymer selected from among polyethylene (PE), polypropylene (PP), polyester, polyamide, polyimide (PI), polyamideimide (PAI), polyetherimide, polyacrylonitrile (PAN), polyvinylidene fluoride (PVDF), polyvinylidene fluoride-hexafluoropropylene (PVDF-HFP), polycarbonate (PC), polyvinyl chloride (PVC), polyvinylidene chloride, polyethylene glycol derivatives, polyoxide, polyvinyl acetate, polystyrene (PS), polyvinylpyrrolidone (PVP), copolymers thereof, or combinations thereof.

14. The electrode assembly for rechargeable lithium batteries as claimed in claim 11, wherein the inorganic layer comprises an inorganic component comprising alumina (Al₂O₃), boehmite (aluminum oxide hydroxide), zirconia, titanium oxide (TiO₂), silica (SiO₂), or a combination thereof.

15. The electrode assembly for rechargeable lithium batteries as claimed in claim 1, wherein the negative electrode active material layer comprises a carbon-based active material as a negative electrode active material.

16. The electrode assembly for rechargeable lithium batteries as claimed in claim 1, wherein the positive electrode comprises a positive electrode active material layer comprising at least one selected from among composite oxides of a metal selected from among cobalt, manganese, nickel and combinations thereof with lithium.

17. A rechargeable lithium battery comprising the electrode assembly as claimed in claim 1 and an electrolyte.
